(19) United States
(12) Patent Application Publication
(10) Pub. No.: US 2018/0304815 A1
(43) Pub. Date: Oct. 25, 2018

(54) INTELLIGENT LIGHT REFLECTION ADJUSTING DEVICE, ADJUSTING METHOD THEREOF AND ANTI-DAZZLE REARVIEW MIRROR

(71) Applicant: BOE TECHNOLOGY GROUP CO., LTD.

(72) Inventor: Lin ZHU, Beijing (CN)

(21) Appl. No.: 15/560,106

(22) PCT Filed: May 10, 2017
(86) PCT No.: PCT/CN17/83754

§ 371 Date: Sep. 20, 2017

(30) Foreign Application Priority Data
Jun. 27, 2016 (CN) 201610483590.7

(51) Int. Cl. B60R 1/08; G02F 1/155; G02F 1/163

(52) U.S. Cl. CPC B60R 1/088; G02F 2001/1635; G02F 1/163; G02F 1/155

(57) ABSTRACT

The invention discloses an intelligent light reflection adjusting device including: a light sensing module, a processing module, a power supply module and a light reflection module. The light sensing module converts a light signal sensed in a first direction into a first electrical signal, converts a light signal sensed in a second direction into a second electrical signal, and outputs the first and second electrical signals to the processing module. The processing module matches an absolute value of the difference between the first and second electric signals with a plurality of preset sections and outputs a control signal corresponding to the matched preset section to the power supply module. The power supply module converts the control signal into a power supply signal and outputs the power supply signal to the light reflection module. The light reflection module reduces a transmittance of a reflected light signal by the power supply signal.

### CROSS-REFERENCE TO RELATED APPLICATIONS

This application is the 371 application of PCT Application No. PCT/CN2017/083754, filed May 10, 2017, which is based upon and claims priority to Chinese Patent Application No. 201610483590.7, filed Jun. 27, 2016, the entire contents of which are incorporated herein by reference.

### TECHNICAL FIELD

The present disclosure relates to the field of display technology, and more particularly to an intelligent light reflection adjusting device, an adjusting method thereof, and an anti-dazzle rearview mirror.

### BACKGROUND

Dazzle refers to a visual condition which may cause visual discomfort and reduce the visibility of objects due to an unfavorable brightness distribution or extreme brightness contrast in space or time in the visual field. The bright feeling which cannot be adapted by human eyes in the visual field may cause people disgusting, uncomfortable or even blind. In the visual field, too high brightness occurs in a local area or brightness changes too fast will result in dazzle, which causing human eyes discomfort, and dazzle is one of the important causes of visual fatigue. Dazzle can be caused by the reflection of outdoor light on the lens or other surfaces, it has a certain impact on the eyes and cause eye discomfort. In driving or outdoor sports, dazzle is very likely to lead to sudden accidents, and thus endanger people's lives and properties.

### SUMMARY

The embodiment according to the present disclosure provides an intelligent light reflection adjusting device comprising: a light sensing module, a processing module, a power supply module and a light reflection module, wherein,

The light sensing module is used for converting a light signal sensed in a first direction into a first electrical signal, converting a light signal sensed in a second direction into a second electrical signal, and outputting the first electrical signal and the second electrical signal to the processing module;

The processing module is used for matching an absolute value of the difference between the first electric signal and the second electric signal with a plurality of preset sections and outputting a control signal corresponding to the matched preset section to the power supply module;

The power supply module is used for converting the control signal into a power supply signal and outputting the power supply signal to the light reflection module; and

The light reflection module is used for reducing the transmittance of the reflected light signal under control of the power supply signal.

The embodiment according to the present disclosure provides an anti-dazzle rearview mirror comprising the intelligent light reflection adjusting device provided in the embodiment according to the present disclosure.

The embodiment according to the present disclosure provides an adjusting method of the intelligent light reflection adjusting device provided in the embodiment according to the present disclosure, comprising:

Converting a light signal sensed in a first direction into a first electrical signal, converting a light signal sensed in a second direction into a second electrical signal;

Matching an absolute value of the difference between the first electric signal and the second electric signal with a plurality of preset sections and outputting a control signal corresponding to the matched preset section;

Converting the control signal into a power supply signal; and

Reducing the transmittance of the reflected light signal under control of the power supply signal.

### BRIEF DESCRIPTION OF THE DRAWINGS

FIG. 1 is a schematic structural view of an intelligent light reflection adjusting device provided in the embodiment according to the present disclosure;

FIG. 2 is a graph of the correspondence curve between the light signal and the electrical signal provided in the embodiment according to the present disclosure;

FIG. 3 is a schematic diagram of a pulse signal provided in the embodiment according to the present disclosure;

FIG. 4 is a schematic structural view of an intelligent light reflection adjusting device provided in the embodiment according to the present disclosure;

FIG. 5 is a schematic structural view of a light reflection module provided in the embodiment according to the present disclosure;

FIG. 6 is a schematic diagram of the principle of discoloration of the electrochromic layer provided by the present embodiment;

FIG. 7 is a flow chart of the adjusting method of the intelligent light reflection adjusting device provided in the embodiment according to the present disclosure;

FIG. 8 is a flow chart showing a specific adjusting method of the intelligent light reflection adjusting device provided in the embodiment according to the present disclosure.

### DETAILED DESCRIPTION

Hereinafter, specific embodiments of the intelligent light reflection adjusting device, the adjusting method thereof, and the anti-dazzle rearview mirror will be described in detail with reference to the accompanying drawings.

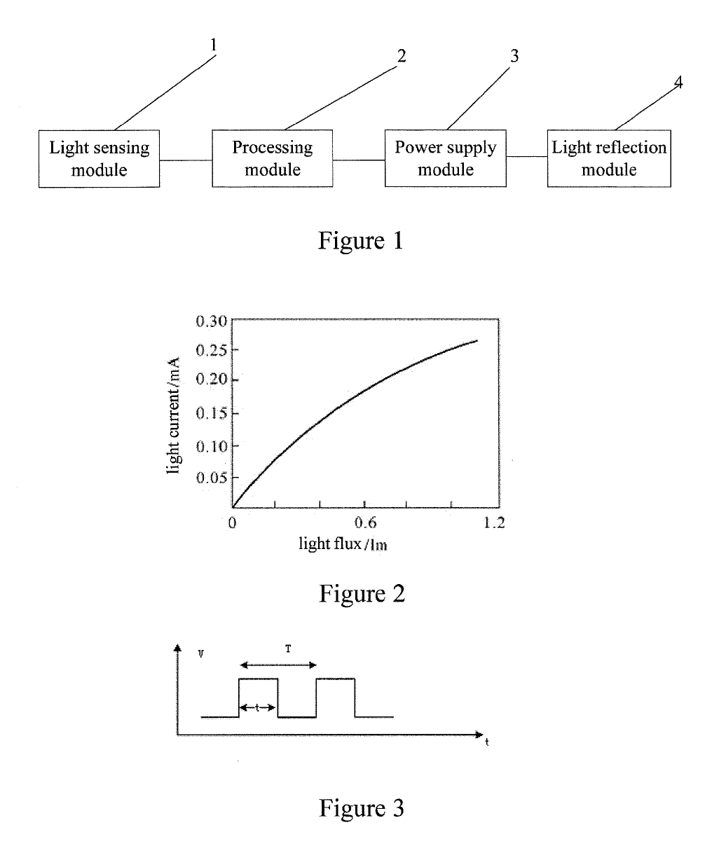

The embodiment according to the present disclosure provides an intelligent light reflection adjusting device, as shown in FIG. 1, which may comprise: a light sensing module 1, a processing module 2, a power supply module 3 and a light reflection module 4, wherein the light sensing module 1 is used for converting a light signal sensed in a first direction into a first electrical signal, converting a light signal sensed in a second direction into a second electrical signal, and outputting the first electrical signal and the second electrical signal to the processing module 2; the processing module 2 is used for matching an absolute value of the difference between the first electric signal and the second electric signal with a plurality of preset sections and outputting a control signal corresponding to the matched preset section to the power supply module 3; the power supply module 3 is used for converting the control signal into a power supply signal and outputting the power supply signal to the light reflection module 4; and the light reflection module 4 is used for reducing the transmittance of the reflected light signal under control of the power supply signal.

In the intelligent light reflection adjusting device provided by the embodiment according to the present disclosure, a light sensing module converts the light signals sensed in the first direction and the second direction into electrical signals; the processing module calculates the converted electrical signals and matches with the preset sections and determines the corresponding control signal according to the matching result. The power supply module converts the control signal into a power supply signal; and the light reflection module can reduce the transmittance of the reflected light under control of the power supply signal, thereby reducing the intensity of the light entering human eyes and preventing dazzle from causing harm to human beings.

In the implementation, in the intelligent light reflection adjusting device provided by the embodiment according to the present disclosure, the processing module is used for: calculating an absolute value of the difference between the first electrical signal and the second electrical signal; setting a preset threshold, dividing the range from zero to the preset threshold into N preset sections, wherein N is a positive integer; matching the absolute value with the preset sections, determining the preset section corresponding to the absolute value, and outputting a control signal corresponding to the preset section to the power supply module. Specifically, a preset threshold value M is set and 0−M is divided into a plurality of preset sections. When the absolute values of the difference between the electrical signals corresponding to the light signals of the first direction and the second direction in different preset sections, different control signals are determined, and the different control signals are converted into different power supply signals, so that the light reflection module can reduce the transmittance of the reflected light in different degrees under the control of different power supply signals, and can also save energy while avoiding dazzle.

In the implementation, in the intelligent light reflection adjusting device provided by the embodiment according to the present disclosure, the N preset sections are equally divided sections, and the endpoint values of each of the preset sections are In=(M/N)*n, wherein M represents the preset threshold, N indicates the number of preset sections, and n is a positive integer. s shown in FIG. 2, the light signal is proportional to the electrical signal, so that the light sensing module can convert the sensed light signal into an electrical signal, and the processing module can perform data processing on the electrical signal. For example, the preset threshold value M is set to be the current data corresponding to the light signal when the light flux is 15000 LUX, but, of course in the practical application other values can be set based on the actual application conditions, and it is not limited here. 0−M is equally divided into N sections, and the endpoint values of each of the preset sections are In=(M/N)*n, from small to large are I₁, I₂, I₃, I₄ . . . In; and the corresponding equally divided sections are the first preset section [I₁ I₂], the second preset section [I₂ I₃], the third preset section [I₃ I₄]and the m^{th} preset section [Iₙ₋₁ Iₙ], respectively. The processing module may calculate an absolute value of the difference between the electrical signals corresponding to the light signals of the first direction and the second direction and determine the preset section in which the absolute value locates. A preset section corresponds to a control signal, and the processing module outputs the control signal corresponding to the determined preset section to the power supply module, and the power supply module converts the control signal into a corresponding power supply signal, so that the light reflection module can reduce the transmittance of the reflected light under the control of the power supply signals, and can also save energy while avoiding dazzle.

In the implementation, in the intelligent light reflection adjusting device provided by the embodiment according to the present disclosure, the processing module can further be used for: when the first electrical signal and/or the second electrical signal are determined to be greater than the preset threshold, outputting a preset control signal to the power supply module, wherein the preset control signal is used to be converted by the power supply module into a preset power supply signal and outputted to the light reflection module; when the absolute value is determined to be less than the minimum endpoint value, outputting a zero-level control signal to the power supply module, wherein the zero-level control signal is used to turn off the power supply module so that the power supply module does not output a power supply signal to the light reflection module. When the intensities of the light signals in the first direction and the second direction (e.g., the front and the rear of the vehicle during driving) are greater than the preset threshold, that is, one of the light signals sensed in the front and in the rear, or both is greater than the preset threshold, the preset control signal is output to the power supply module, and the power module generates the corresponding preset power supply signal and outputs it to the light reflection module, and controls the light reflection module to turn on the maximum anti-dazzle mode, that is, the transmittance of the reflected light is minimized. When the absolute value of the difference between the electrical signals corresponding to the front and rear light signal intensities is smaller than the minimum endpoint value I₁, zero-level control signal is output to the power supply module, then the power supply module will not output power supply signal to the light reflection module, which does not need to adjust the transmittance of reflected light. Thus, energy-saving control of intelligent light reflection adjusting device can be achieved.

In the implementation, in the intelligent light reflection adjusting device provided by the embodiment according to the present disclosure, the control signal outputted by the processing module to the power supply module may be a pulse signal; and the duty ratio of the pulse signal may be obtained by the following formula: Dm=(m/N)*T; where Dm indicates the duty ratio of the pulse signal, T indicates the period of the pulse signal, and m represents the m^{th} preset section. As an example, the general pulse signal is shown in FIG. 3, the duty ratio D=t/T, where t indicates the duration time of high level, and T indicates the period of the pulse signal. The processing module of the intelligent light reflection adjusting device provided by the embodiment according to the present disclosure can output the pulse signal corresponding to the duty ratio according to the matching result, that is the preset section corresponding to the absolute value of the difference between the electrical signals corresponding to the light signal intensity of the first direction and the second direction, and the power supply module outputs the corresponding power supply signal under the control of the corresponding pulse signal of the duty ratio. For example, the preset threshold M is divided into 10 equal sections, and the absolute value of the difference of the electrical signal corresponding to the light signal intensity of the first direction and the second direction is located in the third preset section, that is, the absolute value is greater than or equal to I₃ and less than I₄, then the processing module outputs the corresponding pulse signal D₃=(3/10)*T to the power supply module.

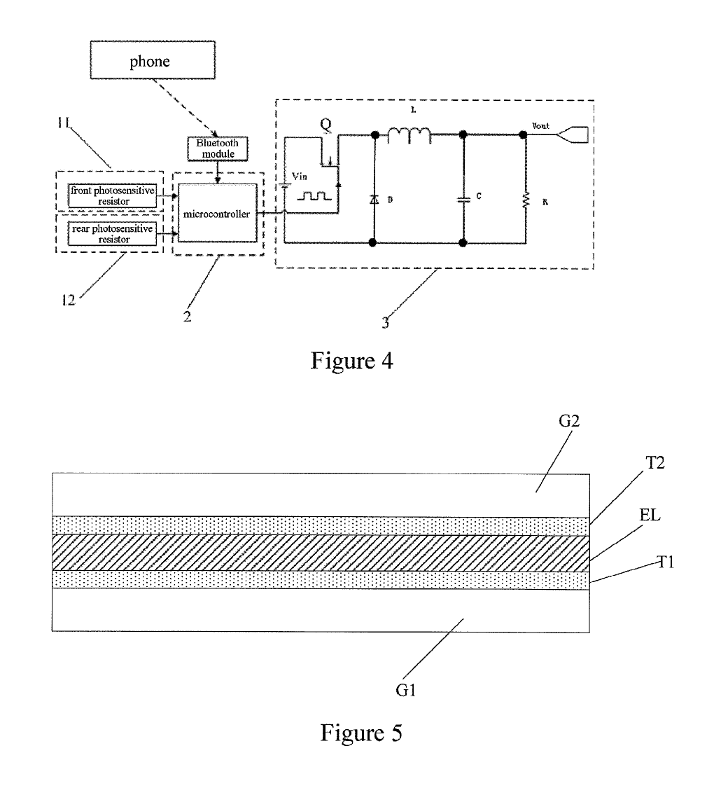

In addition, as shown in FIG. 4, the setting of the number of the preset sections can be set by an intelligent device in wireless connection with the intelligent light reflection device. For example, a phone can be wirelessly connected with the processing module by the Bluetooth module, and then the relevant parameters can be set by means of a corresponding application interface on the phone, so that users can easily set the relevant parameters by using intelligent devices.

In the implementation, in the intelligent light reflection adjusting device provided by the embodiment according to the present disclosure, as shown in FIG. 4, the light sensing module may include a first light sensor 11 and a second light sensor 12, wherein the first light sensor 11 is used for converting the light signal sensed in a first direction into a first electrical signal and outputting to the processing module 2; and the second light sensor 12 is used for converting the light signal sensed in a second direction into a second electrical signal and outputting to the processing module 2. In particular, the first light sensor and the second light sensor may be implemented with photosensitive resistors, as shown in FIG. 4. The first light sensor can be realized by the front photosensitive resistor, the second light sensor can be realized by the rear photosensitive resistor. Of course, other devices that can realize photoelectric conversion may be used, and are not limited thereto.

In the implementation, in the intelligent light reflection adjusting device provided by the embodiment according to the present disclosure, as shown in FIG. 4, the processing module may be a single chip with data processing function. Alternatively, the single chip can convert the light signals into electrical signals and output the corresponding pulse control signals.

In the implementation, in the intelligent light reflection adjusting device provided by the embodiment according to the present disclosure, as shown in FIG. 4, the power supply module 3 may comprise a DC power source Vin, a switching transistor Q, a diode D, an inductance coil L, a capacitor C and a resistor R, wherein the anode of the DC power supply Vin is connected with the source electrode of the switching transistor Q, the negative pole is respectively connected with the positive pole of the diode D, one terminal of the capacitor C and one terminal of the resistor R; the gate electrode of the switching transistor Q is connected with the output terminal of the processing module 2, the drain electrode is respectively connected with the negative pole of the diode D and one terminal of the inductance coil L; and the other terminal of the inductance coil L is respectively connected with the other terminal of the capacitor C, the other terminal of the resistor R and the signal output terminal Vout; wherein the signal output terminal Vout is used for inputting a power supply signal to the light reflection module 4. In particular, the power supply module may be a switching power supply circuit, its corresponding structure and working principle are the same as in the prior art. Power supply module output power supply signal Vout=Vin*Dm, that is, the power module correspondingly outputs different power supply signals corresponding to the pulse signal of the different duty ratio output by the processing module. Finally, the light reflection module reduces the transmittance of the reflected light to varying degrees under the control of different power supply signals, which can achieve anti-dazzle and energy-saving in combine.

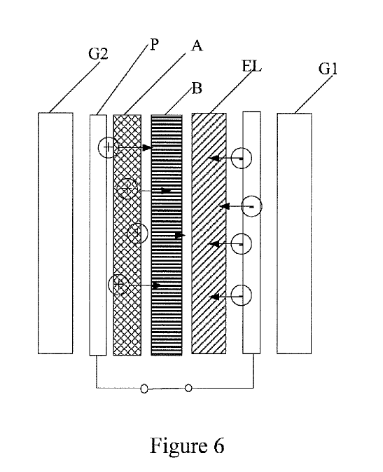

In the implementation, in the intelligent light reflection adjusting device provided by the embodiment according to the present disclosure, as shown in FIG. 5, the light reflection module includes a first glass substrate G1, a first transparent electrode layer T1, an electrochromic layer EL, a second transparent electrode layer T2, and a second glass substrate G2, wherein the transmittance of the electrochromic layer becomes lower as the applied power supply signal increases. In particular, the electrochromic material of the electrochromic layer triggers a redox reaction in the case where the power is on, i.e., the application of an electrical signal, to cause discoloration; when the power is off, the reaction reversibly changes and the electrochromic material returns to the transparent state. As shown in FIG. 6, when the power is on, that is, an electrical signal is applied to the electrochromic layer by the first transparent electrode layer and the second transparent electrode layer, the ions in the ion library conductor P move toward the region where the electrochromic material is located so that the electrochromic material undergoes discoloration, thereby affecting the transmittance of the electrochromic layer. It is to be noted that the structure of the electrochromic layer also includes an ion conductor A and an electrolyte B, and the corresponding structure and function thereof are the same as those of the prior art and are not described in detail herein. Such discoloration of the electrochromic layer, with the strength of the applied power supply signal, the electrochromic layer may correspondingly change the color, and the corresponding change of transmittance may occur. And then by adjusting the power supply signal input into the light reflection module by the power supply module, the anti-dazzle function can be achieved.

Based on the same inventive concept, the embodiment according to the present disclosure provides an anti-dazzle rearview mirror comprising the intelligent light reflection adjusting device provided in the embodiment according to the present disclosure. In particular, the intelligent light reflection adjusting device can be integrated in the rearview mirror of an automobile, and control the reflected light transmittance according to light intensities on the rearview mirror from the car in front and the car in rear (coressponding to the first direction and the second direction), achieving a combination of anti-dazzle and display at the same time, while also saving energy.

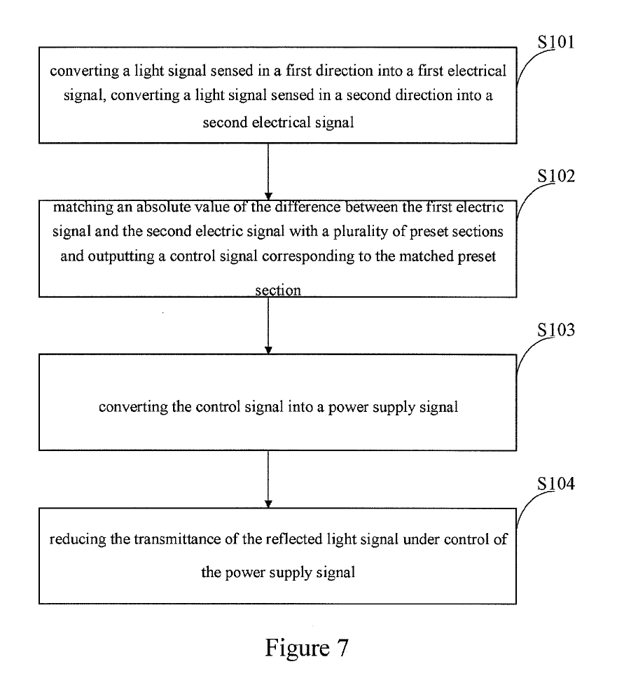

Based on the same inventive concept, the embodiment according to the present disclosure provides an adjusting method of the intelligent light reflection adjusting device provided in the embodiment according to the present disclosure, as shown in FIG. 7, and may comprises the steps as follows.

In S101, a light signal sensed in a first direction is converted into a first electrical signal, converting a light signal sensed in a second direction into a second electrical signal.

In S102, an absolute value of the difference between the first electric signal and the second electric signal is matched with a plurality of preset sections and outputting a control signal corresponding to the matched preset section.

In S103, the control signal is converted into a power supply signal.

In S104, the transmittance of the reflected light signal is reduced under control of the power supply signal.

In the adjusting method of the intelligent light reflection adjusting device provided in the embodiment according to the present disclosure, by converting the light signals sensed in the first direction and the second direction into electrical signals; calculating the converted electrical signals and matching them with the preset sections; and determining the corresponding control signals according to the matching result, the control signals are converted into power supply signals; and the transmittance of the reflected light is reduced under the control of the power supply signals, thereby reducing the intensity of the light entering human eyes and preventing dazzle from causing harm to human beings. That is, the reflected light transmittance is adjusted according to the strength of the front and rear lights, to achieve a smart anti-dazzle function.

In the implementation, in the adjusting method provided in the embodiment according to the present disclosure, step S102 may include: calculating an absolute value of the difference between the first electrical signal and the second electrical signal; setting a preset threshold, dividing the range from zero to the preset threshold into N preset sections, wherein N is a positive integer; and matching the absolute value with the preset sections, determining the preset section corresponding to the absolute value, and outputting a control signal corresponding to the preset section. In particular, the preset threshold may be divided into a plurality of preset sections, so that according to the different determined preset sections in which the absolute value of the difference between the light signals of the first direction and the second direction is located, corresponding control signal is output. The corresponding control signal generates the corresponding power supply signal, and then the light reflection module can reduce the transmittance of reflected light at different amplitudes in correspondence with the different power supply signals, achieving both the purpose of anti-dazzle and energy saving.

In the implementation, in the adjusting method provided in the embodiment according to the present disclosure, the N preset sections are equally divided sections, and the endpoint values of each of the preset sections are In=(M/N)*n, wherein M represents the preset threshold, N indicates the number of preset sections, and n is a positive integer. 0−M is equally divided into N sections, and the endpoint values of each of the preset sections are In=(M/N)*n, from small to large are I₁, I₂, I₃, I₄ . . . In; and the corresponding equally divided sections are the first preset section [I₁ I₂], the second preset section [I₁ I₂], the third preset section [I₁ I₂] . . . and the m^{th} preset section [Iₙ₋₁ Iₙ], respectively. The absolute value of the difference between the electrical signals corresponding to the light signals of the first direction and the second direction is calculated as such and the preset section as described above in which the absolute value locates is determined. A preset section corresponds to a control signal, so that the control signal corresponding to the determined preset section is output, and the control signal is converted into a corresponding power supply signal. Then, the transmittance of the reflected light is reduced under the control of the power supply signals, and it can also save energy while avoiding dazzle.

In the implementation, the adjusting method provided in the embodiment according to the present disclosure also may comprise: when the first electrical signal and/or the second electrical signal are determined to be greater than the preset threshold, outputting a preset control signal to the power supply module, wherein the preset control signal is used to be converted by the power supply module into a preset power supply signal and outputted to the light reflection module; when the absolute value is determined to be less than the minimum endpoint value, outputting a zero-level control signal to the power supply module, wherein the zero-level control signal is used to turn off the power supply module so that the power supply module does not output a power supply signal to the light reflection module. When the intensities of the light signals in the first direction and the second direction (e.g., the front and the rear of the vehicle during driving) are greater than the preset threshold, that is, one of the light signals sensed in the front and in the rear, or both is greater than the preset threshold, the preset control signal is output, and the corresponding preset power supply signal is generated in accordance with the preset control signal, then the maximum anti-dazzle mode is turn on, that is, the transmittance of the reflected light is minimized. When the absolute value of the difference between the electrical signals corresponding to the front and rear light signal intensities is smaller than the minimum endpoint value Ii, zero-level control signal is output to the power supply module, which does not need to adjust the transmittance of reflected light. This can achieve energy-saving control of intelligent light reflection adjusting device.

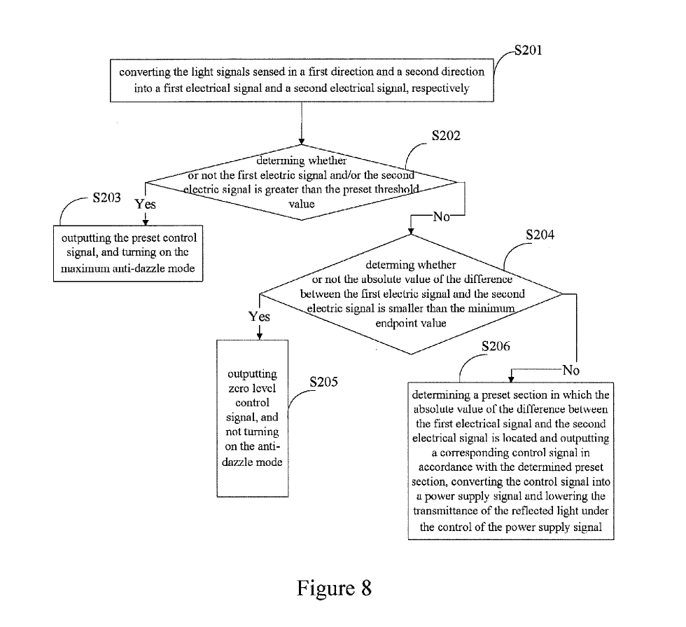

The adjusting process of the intelligent light reflection adjusting device provided in the embodiment according to the present disclosure may be as shown in FIG. 8, and the process may include the steps as follows.

In S201, the light signals sensed in a first direction and a second direction are converted into a first electrical signal and a second electrical signal, respectively.

In S202, it is determined whether or not the first electric signal and/or the second electric signal is greater than the preset threshold value. If Yes, then step S203 is executed; otherwise, step S204 is executed.

In S203, the preset control signal is output, and the maximum anti-dazzle mode is turned on.

In S204, it is determed whether or not the absolute value of the difference between the first electric signal and the second electric signal is smaller than the minimum endpoint value. If Yes, the step S205 is executed; otherwise, step S206 is executed.

In S205, zero-level control signal is output, and the anti-dazzle mode is not turned on.

In S206, it is determined a preset section in which the absolute value of the difference between the first electrical signal and the second electrical signal is located and outputting a corresponding control signal in accordance with the determined preset section, and the control signal is converted into a power supply signal and the transmittance of the reflected light is reduced under the control of the power supply signal.

In the implementation, in the adjusting method provided in the embodiment according to the present disclosure, the control signal is a pulse signal; and the duty ratio of the pulse signal is obtained by the following formula: Dm=(m/N)*T; where Dm indicates the duty ratio of the pulse signal, T indicates the period of the pulse signal, and m indicates the m^{th} preset section. Specially, the pulse signal corresponding to the duty ratio is output according to the preset section corresponding to the absolute value of the difference between the electrical signals corresponding to the light signal intensity of the first direction and the second direction, and then the corresponding power supply signal is output under the control of the corresponding pulse signal of the duty ratio. The transmittance of the reflected light can be correspondingly decreased under the control of the power supply signal to achieve anti-dazzle function.

The embodiment according to the present disclosure provides an intelligent light reflection adjusting device, an adjusting method thereof, and an anti-dazzle rearview mirror. The intelligent light reflection adjusting device comprises: a light sensing module, a processing module, a power supply module and a light reflection module, wherein the light sensing module is used for converting a light signal sensed in a first direction into a first electrical signal, converting a light signal sensed in a second direction into a second electrical signal, and outputting the first electrical signal and the second electrical signal to the processing module; the processing module is used for matching an absolute value of the difference between the first electric signal and the second electric signal with a plurality of preset sections and outputting a control signal corresponding to the matched preset section to the power supply module; the power supply module is used for converting the control signal into a power supply signal and outputting to the light reflection module; and the light reflection module is used for reducing the transmittance of the reflected light signal under control of the power supply signal. Such an intelligent light reflection adjusting device converts the light signals sensed in the first direction and the second direction into electrical signals through a light sensing module; calculates the converted electrical signals by the processing module and matches with the preset sections; and determines the corresponding control signal according to the matching result. The power supply module converts the control signal into a power supply signal; and the light reflection module can reduce the transmittance of the reflected light under control of the power supply signal, thereby reducing the intensity of the light entering human eyes and preventing dazzle from hurting human eyes.

It will be apparent to those skilled in the art that various changes and modifications can be made in this disclosure without departing from the spirit and scope of the present disclosure. In this way, the present disclosure is intended to embrace such variations and variations if these modifications and variations of this disclosure are within the scope of the present disclosure and the equivalents thereof.

1. An intelligent light reflection adjusting device comprising: a light sensing module, a processing module, a power supply module and a light reflection module, wherein
the light sensing module is configured to convert a light signal sensed in a first direction into a first electrical signal, to convert a light signal sensed in a second direction into a second electrical signal, and to output the first electrical signal and the second electrical signal to the processing module;
the processing module is configured to match an absolute value of the difference between the first electric signal and the second electric signal with a plurality of preset sections and to output a control signal corresponding to the matched preset section to the power supply module;
the power supply module is configured to convert the control signal into a power supply signal and to output the power supply signal to the light reflection module; and
the light reflection module is configured to reduce a transmittance of a reflected light signal under control of the power supply signal.

2. The intelligent light reflection adjusting device according to claim 1, wherein the processing module is configured to:
calculate the absolute value of the difference between the first electrical signal and the second electrical signal; and
set a preset threshold, to divide a range from zero to the preset threshold into N preset sections, wherein N is a positive integer; to matches the absolute value with the preset sections, to determine the preset section corresponding to the absolute value, and to output the control signal that is corresponding to the preset section to the power supply module.

3. The intelligent light reflection adjusting device according to claim 2, wherein the N preset sections are equally divided sections, and the endpoint values of each of the preset sections are In=(M/N)*n, wherein M represents the preset threshold, N indicates the number of the preset sections, and n is a positive integer.

4. The intelligent light reflection adjusting device according to claim 3, wherein the processing module is further configured to:
when the first electrical signal and/or the second electrical signal are determined to be greater than the preset threshold, output a preset control signal to the power supply module;
wherein the preset control signal is configured to be converted by the power supply module into a preset power supply signal and outputted to the light reflection module;
when the absolute value is determined to be less than the minimum endpoint value, output a zero-level control signal to the power supply module, wherein the zero-level control signal is configured to turn off the power supply module.

5. The intelligent light reflection adjusting device according to claim 4, wherein the control signal outputted by the processing module to the power supply module is a pulse signal; and the duty ratio of the pulse signal is calculated by the following formula:
Dm=(m/N)*T;
where Dm indicates the duty ratio of the pulse signal, T indicates the period of the pulse signal, and m indicates the m^{th} preset section.

6. The intelligent light reflection adjusting device according to claim 1, wherein the light sensing module comprises a first light sensor and a second light sensor, wherein,
the first light sensor is configured to convert the light signal sensed in the first direction into the first electrical signal and to output to the processing module; and
the second light sensor is configured to convert the light signal sensed in the second direction into the second electrical signal and to output to the processing module.

7. The intelligent light reflection adjusting device according to claim 6, wherein each of the first light sensor and the second light sensor comprises a photosensitive resistor.

8. The intelligent light reflection adjusting device according to claim 1, wherein the processing module is a microcontroller with data processing function.

9. The intelligent light reflection adjusting device according to claim 1, wherein the power supply module comprises a DC power source, a switching transistor, a diode, an inductance coil, a capacitor and a resistor, wherein
the anode of the DC power supply is connected with the source electrode of the switching transistor, the negative pole is connected with the positive pole of the diode, one terminal of the capacitor and one terminal of the resistor, respectively;
the gate electrode of the switching transistor is connected with the output terminal of the processing module, the drain electrode is connected with the negative pole of the diode and one terminal of the inductance coil, respectively; and
the other terminal of the inductance coil is connected with the other terminal of the capacitor, the other terminal of the resistor and the signal output terminal, respectively; wherein the signal output terminal is configured to input a power supply signal to the light reflection module.

10. The intelligent light reflection adjusting device according to claim 1, wherein the light reflection module comprises a first glass substrate, a first transparent electrode layer, an electrochromic layer, a second transparent electrode layer, and a second glass substrate, wherein
the transmittance of the electrochromic layer becomes lower as the applied power supply signal increases.

11. An anti-dazzle rearview mirror comprising the intelligent light reflection adjusting device according to claim 1.

12. An adjusting method of the intelligent light reflection adjusting device according to claim 1, comprising:
converting the light signal sensed in the first direction into the first electrical signal, converting the light signal sensed in the second direction into the second electrical signal;
matching the absolute value of the difference between the first electric signal and the second electric signal with the plurality of preset sections and outputting the control signal that is corresponding to the matched preset section;
converting the control signal into the power supply signal; and
reducing the transmittance of the reflected light signal under the control of the power supply signal.

13. The adjusting method according to claim 12, wherein the step of matching the absolute value of the difference between the first electric signal and the second electric signal with the plurality of preset sections and outputting the control signal that is corresponding to the matched preset section to the power supply module, comprises:
calculating the absolute value of the difference between the first electrical signal and the second electrical signal; setting the preset threshold, dividing the range from zero to the preset threshold into N preset sections, wherein N is a positive integer; and
matching the absolute value with the preset sections, determining the preset section that is corresponding to the absolute value, and outputting the control signal that is corresponding to the preset section.

14. The adjusting method according to claim 13, wherein the N preset sections are equally divided sections, and the endpoint values of each of the preset sections are In=(M/N)*n, wherein M represents the preset threshold, N indicates the number of preset sections, and n is a positive integer.

15. The adjusting method according to claim 14 further comprising:
when the first electrical signal and/or the second electrical signal are determined to be greater than the preset threshold, outputting a preset control signal to the power supply module; wherein the preset control signal is used to be converted by the power supply module into a preset power supply signal and outputted to the light reflection module;
when the absolute value is determined to be less than the minimum endpoint value, outputting a zero-level control signal to the power supply module; wherein the zero-level control signal is used to turn off the power supply module so that the power supply module does not output a power supply signal to the light reflection module.

16. The adjusting method according to claim 15, wherein the control signal is a pulse signal; and the duty ratio of the pulse signal is obtained by the following formula:
Dm=(m/N)*T;
where Dm indicates the duty ratio of the pulse signal, T indicates the period of the pulse signal, and m indicates the m^{th} preset section.

17. The intelligent light reflection adjusting device according to claim 2, wherein the light sensing module comprises a first light sensor and a second light sensor, wherein,
the first light sensor is configured to convert the light signal sensed in the first direction into the first electrical signal and to output to the processing module; and
the second light sensor is configured to convert the light signal sensed in the second direction into the second electrical signal and to output to the processing module.

18. The intelligent light reflection adjusting device according to claim 3, wherein the light sensing module comprises a first light sensor and a second light sensor, wherein,
the first light sensor is configured to convert the light signal sensed in the first direction into the first electrical signal and to output to the processing module; and
the second light sensor is configured to convert the light signal sensed in the second direction into the second electrical signal and to output to the processing module.

19. The intelligent light reflection adjusting device according to claim 4, wherein the light sensing module comprises a first light sensor and a second light sensor, wherein,
the first light sensor is configured to convert the light signal sensed in the first direction into the first electrical signal and to output to the processing module; and
the second light sensor is configured to convert the light signal sensed in the second direction into the second electrical signal and to output to the processing module.

20. The intelligent light reflection adjusting device according to claim 5, wherein the light sensing module comprises a first light sensor and a second light sensor, wherein,
the first light sensor is configured to convert the light signal sensed in the first direction into the first electrical signal and to output to the processing module; and
the second light sensor is configured to convert the light signal sensed in the second direction into the second electrical signal and to output to the processing module.
